(19) United States
(12) Patent Application Publication
(10) Pub. No.: US 2005/0097982 A1
(43) Pub. Date: May 12, 2005

(54) Removable steering wheel having instant connection mechanism

(76) Inventor: Chih-Yu Li, Taipei Hsien (TW)

Correspondence Address: CHIH-YU LI, P.O. BOX 2-83, PAN-CHIAO, TAIPEI HSIEN, 220, TW

(21) Appl. No.: 10/706,175

(22) Filed: Nov. 10, 2003

(51) Int. Cl. G05G 1/10

(52) U.S. Cl. 74/552

(57) ABSTRACT

This invention relates to a removable steering wheel having instant connection mechanism, the removable steering wheel is composed of a locating seat installed on steering wheel, a connection hub connected to steering wheel shaft, a control collar installed on outer circumference of the connection hub, and at least one or more elastic pieces installed between the locating seat and the connection hub. The locating have an extending post which is inserted into the connection hub, one end of the elastic piece being fixed on the connection hub and the other end being formed into a hook part, and the inner circumference of the control collar having a pushing flange, a compression spring being installed between the connection hub and the pushing flange. Once the control collar move forward by elastic force of the compression spring, the pushing flange can press on the hook part to push it into the groove of the locating seat, thus the combined steering wheel and connection hub can connect with locating seat firmly and quickly. On the other hand, the pushing plate will not press on the hook part when the driver pull the control collar backward to the steering wheel, thus the hook part can separate from the groove of the locating seat by its own elasticity, meanwhile the driver can remove the combined steering wheel and connection hub from the locating seat freely.

### BACKGROUND OF THIS INVENTION

(1) Field of the Invention

This invention relates to a removable steering wheel having instant connection mechanism, the removable steering wheel having a locating seat installed on the steering wheel shaft and a connection hub connected to the steering wheel, the connection hub having at least one or more elastic piece, the end of the elastic piece can be pushed to the groove on the locating seat entirely, such that, the locating seat and the connection hub can be connected quickly and firmly with each other.

(2) Description of the Prior Art

For the purpose of promoting the traffic convenience and living standard, the car is used widely in our daily life. However, it is very easy for the thief to steal a car within a few minutes. Although the car owner install various safety device, such as steering wheel lock, gear lever lock or electronic alarm etc., to prevent the theft stealing the car easily, the theft still can steal the car easily by reason of the theft having enough time to sneak into the car and destroy the safety device. Accordingly, the conventional safety lock for car can't stop the theft to steal the car, and the car owner must pay more attention to watch his car.

The applicant of this invention discloses a removable steering wheel having anti-theft device (Taiwan Utility Model Application No. 86215152, Publication No. 352671). The removable steering wheel have a locating seat installed on the steering wheel shaft, a connection hub connected to the steering wheel, a control collar installed on outer circumference of the connection hub, and a compression spring installed between the connection hub and the control hub. One side of the locating seat have an extending post, on the circumference of the extending post having at least one or more fitting grooves, the connection hub having a center hole, the outer circumference of the connection hub having at least one or more depositing grooves in which have respectively a roller, further, the extending post of the locating seat being inserted into the center hole of the connection hub. The inner circumference of the control collar have at least one or more receiving grooves, once the control collar move forward by elastic force of the compression spring, the inner face of the control collar will press on the roller to push it into the fitting groove of the locating seat, thus the combined steering wheel and connection hub can connect with the locating seat. On the other hand, if the driver pull the control collar backward to the steering wheel and remove the combined steering wheel and connection hub from the locating seat, the roller will be pushed back to the receiving groove of the control collar. However, the above removable steering wheel has some defects, such as described as follows:

1. It is very inconvenient for the operator to install the small rollers into the depositing grooves respectively.

2. The locating seat connect with the connection hub by means of the small rollers, the roller must afford a big axial action force or stress, thus the rollers may break or deform in operating process.

3. The combined steering wheel and connection hub can't connect with the locating seat firmly when the rollers have been worn by the friction force between the locating seat and the control collar.

### SUMMARY OF THE INVENTION

It is thereof the main object of this invention to provide a removable steering wheel having instant connection mechanism. The removable steering wheel is composed of a locating seat installed on the steering wheel, a connection hub connected to the steering wheel shaft, a control collar installed on the outer circumference of the connection hub, and an elastic piece installed between the locating seat and the connection hub. The locating seat have an extending post which is inserted into the connection hub, one end of the elastic piece being fixed on the connection hub and the other end being formed into a hook part, and the inner circumference of the control collar having a pushing flange. Once the control collar move forward, the pushing flange can press on the hook part to push it into the groove of the locating seat, thus the combined steering wheel and connection hub can connect with the locating seat firmly and quickly.

### BRIEF DESCRIPTION OF THE DRAWINGS

In the drawings, which illustrate the preferred embodiments and modes of operation of the invention, and in which like reference characters designate the same or similar parts throughout the several views:

FIG. 1 is an exploded view showing a removable steering wheel having instant connection mechanism of this invention;

FIG. 2 is a perspective view showing the assembled removable steering wheel having connection mechanism of this invention;

FIG. 3 is a partial sectional view showing the assembling status for the locating seat and the connection hub of this invention;

FIG. 4 is a partial sectional view showing the disassembling status for the locating seat and the connection hub of this invention; and.

FIG. 5 is a partial sectional view showing the connection hub being removed from the locating seat.

### DETAILED DESCRIPTION OF THE PREFERRED EMBODIMENT

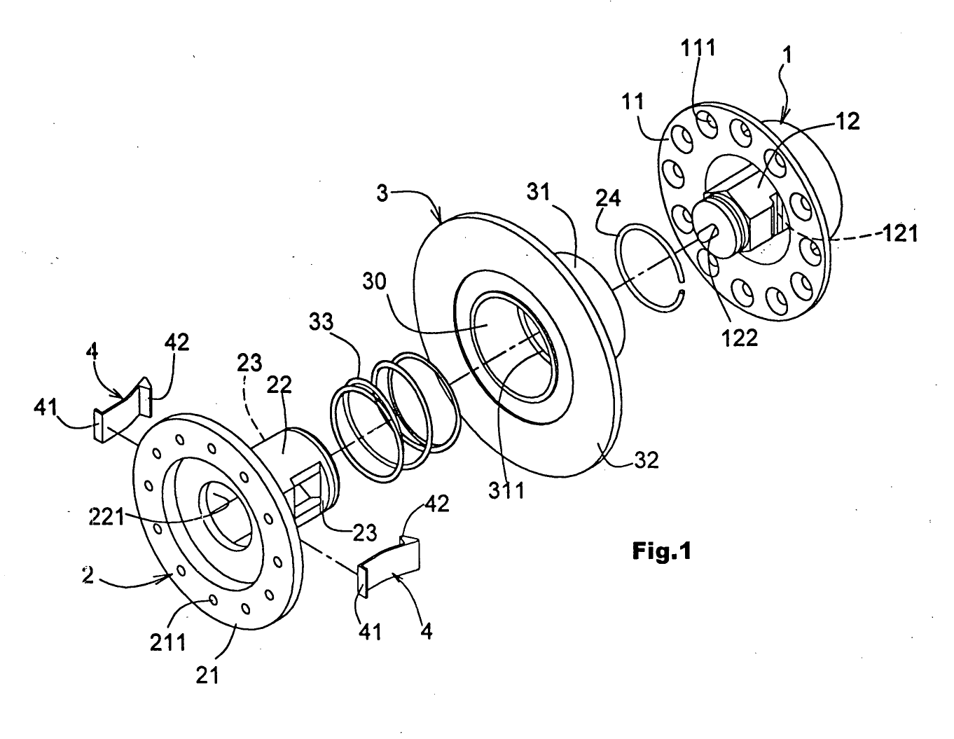

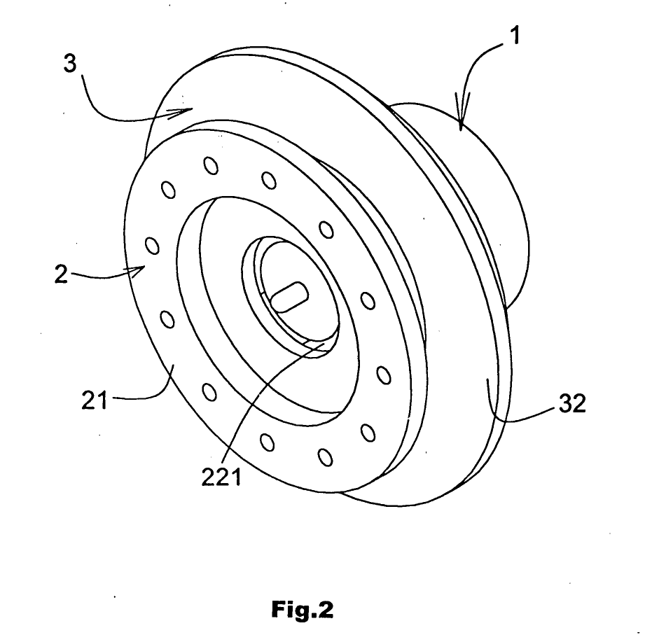

Referring to FIG. 1 and FIG. 2, the present invention, a removable steering wheel having instant connection mechanism, is composed of a locating seat 1 installed on steering wheel shaft 10, a connection hub 2 fixed on steering wheel 20, a control collar 3 installed on the outer circumference of the connection hub 2, and a elastic piece 4 installed between the locating seat 1 and the connection hub 2.

The locating seat 1 have a first fixing flange 11 and an extending post 12, on the first fixing flange 11 having a plurality of first fixing holes 111 to make the locating seat 1 can be fixed on the steering wheel shaft 10 by screwing the fixing bolts 112 into the fixing holes 111 and the steering wheel shaft 10. Further, the circumference of the fixing bolt 12 have at least one or more grooves 121 and the center of the fixing bolt 12 have a through hole 12 for installing horn wire.

The connection hub 2 is composed of a second fixing flange 21 and an extending hub 22, on the second fixing flange 21 have a plurality of second fixing holes 211 to make the connection hub 2 can be fixed on the and can be connected to the steering wheel 20. The extending hub 22 have a center hole 221 and at least one or more aperture 23 formed at its circumference, further, the extending post 12 of the locating seat 1 can be inserted into the center hole 221 of the connection hub 2. The control collar 3 is composed of a collar 31 and a flange 32, wherein the collar 31 having a control hole 30, the inner circumference of the control hole 30 having a pushing flange 311. A compression spring 33 is installed between the second fixing flange 21 and the pushing flange 311 to push the control collar 3 to a presetting position. Furthermore, a retaining ring 24 is installed at the end of the extending hub 22 to prevent the connection hub 2 being pushed out from the control collar 3.

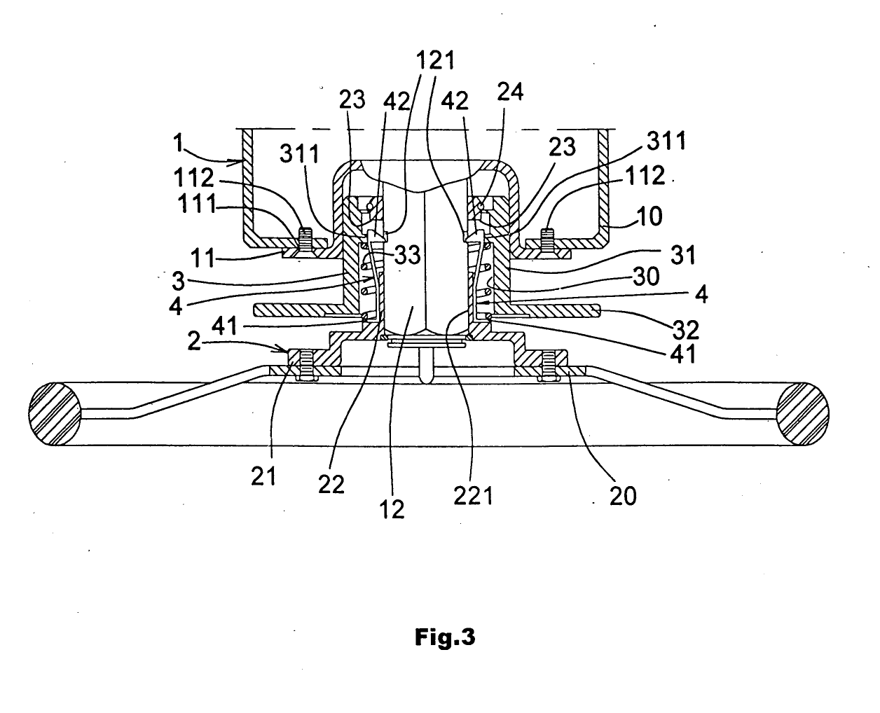

Referring to FIG. 3, the elastic piece 4 is installed between the locating seat 1 and the connection hub 2, one end of the elastic piece 4 being welded on side of the second fixing flange 21 and the other end being formed into a hook part 42, the hook part 42 of the elastic piece 4 can be pushed into the groove 121 through the aperture 23 of the extending hub 22 to connect the locating seat 1, further, the hook part 42 of the elastic piece 4 having more connecting area which can be retained in the groove 121 firmly and can afford more axial action force.

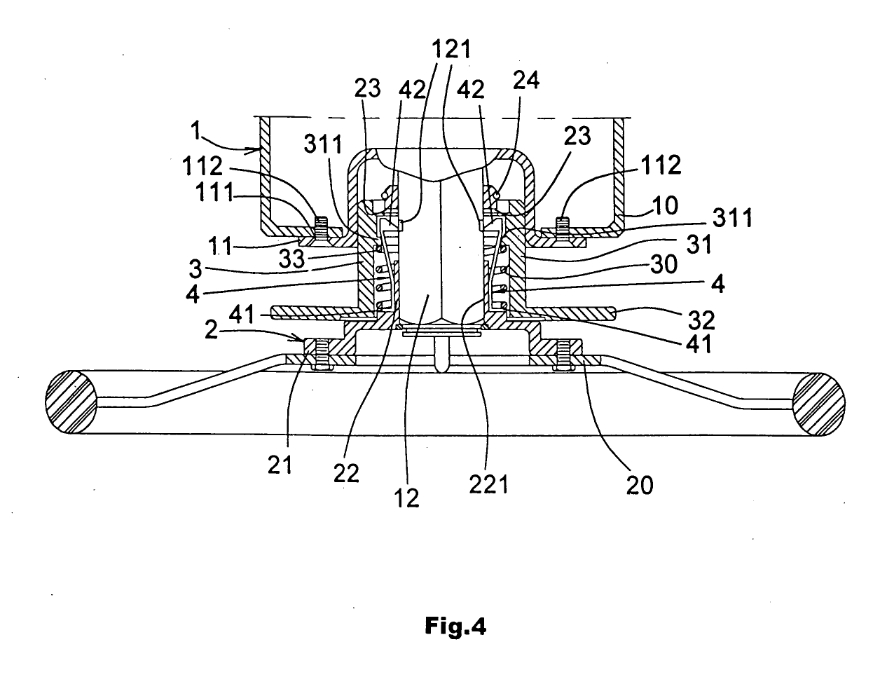

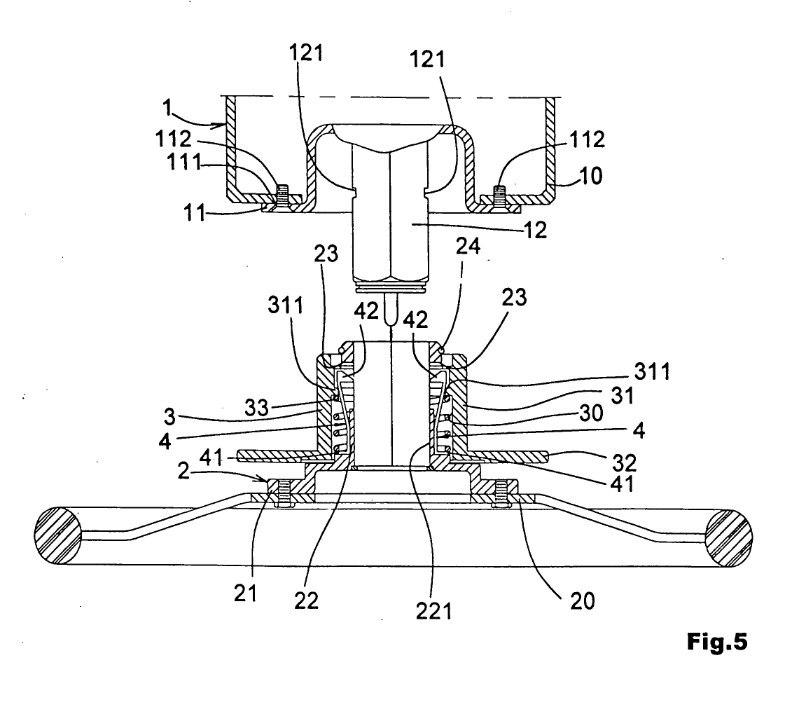

FIG. 4 showing the disassembling status of this invention, the driver press the steering wheel 20 with his palms and pull the flange 32 of the control collar 3 toward the steering wheel 20 with his fingers, thus the pushing flange 311 of the control collar 3 will not press on the hook part 42 of the elastic piece 4 any more, and the hook part 42 of the elastic piece 4 can separate from the groove 121 on the locating seat 1, then the driver can remove the steering wheel 20 and the connection hub 2 from the locating seat 1, such as shown in FIG. 5.

Please refer to FIG. 5 again, if the driver would like to assemble the locating seat 1 and the connection hub 2, he must pull the flange 32 of the control collar 3 toward the steering wheel 20 to make the pushing flange 311 can't press on the hook part 42 of the elastic piece 4, and the hook part 42 of the elastic piece 4 can separate form the groove 121 on the locating seat 1, such as described above, thus the driver can install the combined steering wheel and connection hub 2 on the extending post 12 of the locating seat 1. The control collar 3 can move forward by means of elastic force of the compression spring 33 when the driver release the control collar 3, meanwhile the pushing flange 311 can push and press on the hook part 42 of the elastic piece 4 to make the hook part 42 can be pushed into the groove 121 through the aperture 221 of the extending hub 22 to connect the locating seat 1, such as shown in FIG. 3, thus the combined steering wheel 20 and connection hub 2 can connect with the locating seat 1 firmly and quickly.

It is understood by those skilled in the art that the forgoing description is a preferred device and that various changes and modifications may be made in the invention without departing from the spirit and scope thereof.

1. A removable steering wheel having instant connection mechanism which comprising:
a locating seat installed on steering wheel, the locating seat having an extending post, the circumference of the extending post having at least one or more grooves;
a connection hub connected to steering wheel shaft, the connection hub having a center hole, the circumference of the connection hub having at least one or more apertures, the extending post of said locating sat being inserted into the center hole;
a control collar installed on outer circumference of said connection hub, the inner circumference of the control hub having a pushing flange;
at least one or more elastic pieces installed between said locating seat and said connection hub, one end of the elastic piece being fixed on said connection hub and the other end being form ed into a hook part;
a compression spring installed between said connection hub and said pushing flange;
Once said control collar moving forward by elastic force of said compression, said pushing flange can move to press on the hook part to push it into the groove of said locating seat, thus the combined steering wheel and connection hub can connect with said locating seat firmly and quickly.
